(19) United States
(12) Patent Application Publication
(10) Pub. No.: US 2018/0139081 A1
(43) Pub. Date: May 17, 2018

(54) CYCLIC PREFIX-ALIGNED GENERALIZED AND N-CONTINUOUS ORTHOGONAL FREQUENCY DIVISION MULTIPLEXING

(71) Applicants: INTERDIGITAL PATENT HOLDINGS, INC., Wilmington, DE (US); University of South Florida, Tampa, FL (US)

(72) Inventors: Ertugrul GUVENKAYA, Tampa, FL (US); Erdem BALA, East Meadow, NY (US); Rui YANG, Greenlawn, NY (US); Huseyin ARSLAN, Tampa, FL (US); Alphan SAHIN, Westbury, NY (US); Anas TOM, Tampa, FL (US)

(73) Assignees: INTERDIGITAL PATENT HOLDING, INC., Wilmington, DE (US); University of South Florida, Tampa, FL (US)

(21) Appl. No.: 15/572,691

(22) PCT Filed: May 6, 2016
(86) PCT No.: PCT/US2016/031246

§ 371 Date: Nov. 8, 2017

Related U.S. Application Data
(60) Provisional application No. 62/159,012, filed on May 8, 2015.
(60) Provisional application No. 62/167,207, filed on May 27, 2015.

(51) Int. Cl. H04L 27/26

(52) U.S. Cl. CPC H04L 27/2607; H04L 25/03828; H04L 27/2618

(57) ABSTRACT

A wireless transmit/receive unit (WTRU) may combine an alignment component with an FDM based symbol to produce a signal such that it is aligned to a duration of a CP of the FDM based symbol at a receiver upon reception. A component may be added to one or more subcarriers of the alignment signal to reduce peak-to-average ratio (PAPR) of the signal.

### CROSS REFERENCE TO RELATED APPLICATIONS

This application claims the benefit of U.S. Provisional Application Ser. No. 62/159,012 filed May 8, 2015 and U.S. Provisional Application Ser. No. 62/167,207 filed May 27, 2015, the contents of which are hereby incorporated by reference herein.

### BACKGROUND

Frequency division multiple access (FDMA) or orthogonal frequency-division multiplexing (OFDM) communications may utilize redundancy schemes such as cyclic prefixes (CP) and null subcarriers to provide low error rate and reliable communications. However, to achieve very high data rates and quality of experience (QoE) or quality of service (QoS), the next generation of wireless and wired networks utilizing FDMA or OFDM will require improved management of out-of-band (OOB) emissions and peak-to-average ratios (PAPRs). N-continuous OFDM communications, which keeps up-to N-th order derivatives of the signal at the boundary of adjacent symbols being zero, may help with OOB. N-continuous OFDM communications, although helpful with OOB, may not help reduce PAPR.

Thus, it is desirable to have FDMA or OFDM communications with lower OOB emissions and PAPR to provide very high throughput for next generation applications. Using N-continuous OFDM communications with a simpler receiver architecture and better PAPR performance is also desirable.

### SUMMARY

A distortion component may be added to subcarriers of an orthogonal frequency division multiplexed (OFDM) or N-continuous OFDM signal. An alignment component may be added to the signal to utilize a CP duration or portion based on the distortion component. The alignment component may also be used with a subcarrier spacing related to a subcarrier spacing of a data or control information component of the N-continuous OFDM signal and may be configured to reduce peak-to-average ratio (PAPR) of a transmission.

Similar to utilization of an alignment component, a suppressing signal may be generated to utilize the CP duration or portion and non-utilized subcarriers of a signal. Multi-stream suppression alignment may be used in connection with different channel conditions, configurations, regions, and zones between communicating devices. The multi-stream suppressing signal may be used in regions or zones with limited transmission energy or power.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of another example radio access network and another example core network that may be used within the communications system illustrated in FIG. 1A;

FIG. 2 shows graphs illustrating components of a transmitted signal;

FIG. 3 shows graphs illustrating a cyclic prefix (CP) removal operation after transmission over a multipath channel;

FIG. 4 is a block diagram of processing data or control information;

FIG. 5 is an illustration of communicating alignment components with a CP duration or portion;

FIG. 6 is an illustration of suppressing alignment for multiple WTRUs that may utilize channel state information (CSI);

FIG. 7 is an illustration of multiple-input multiple-output (MIMO) alignment for a single WTRU that may utilize CSI;

FIG. 8 is an illustration of MIMO suppressing alignment for multiple WTRUs that may utilize CSI;

FIG. 9 shows an example of bit error rates (BER) for a hypothetical OFDM communication;

FIG. 10 is a graph of power spectral density (PSD) for single WTRU and multiple WTRU configurations;

FIG. 11 is a process for generating, transmitting, and receiving a signal in accordance with the examples given herewith; and

FIG. 12 is a process for generating a suppression signal with CSI for multiple WTRUs.

### DETAILED DESCRIPTION

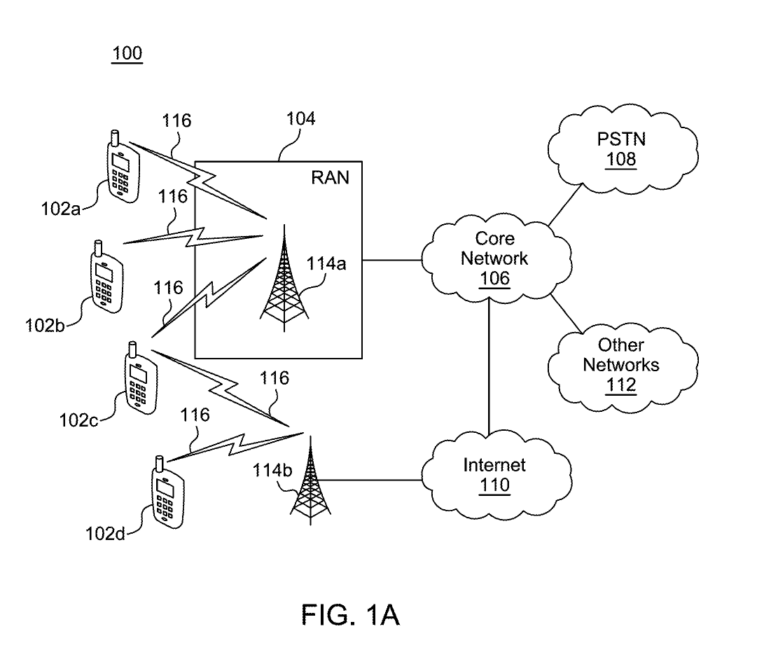

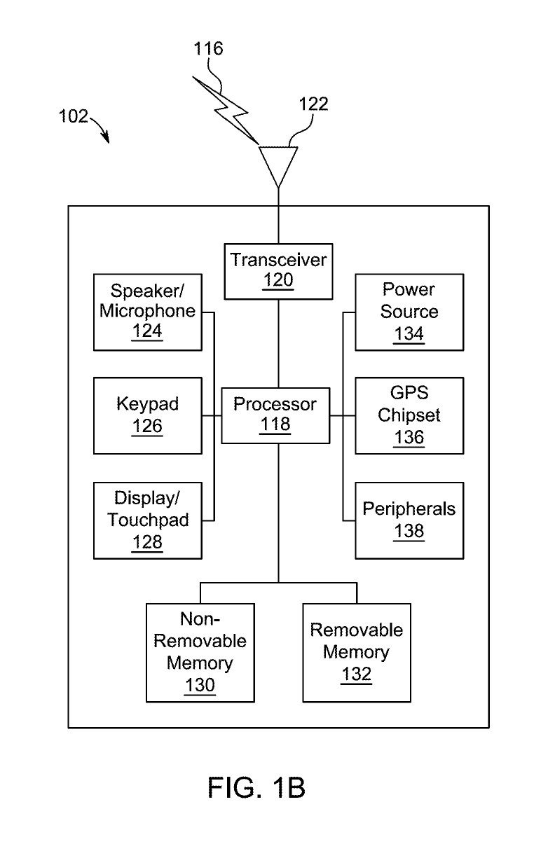

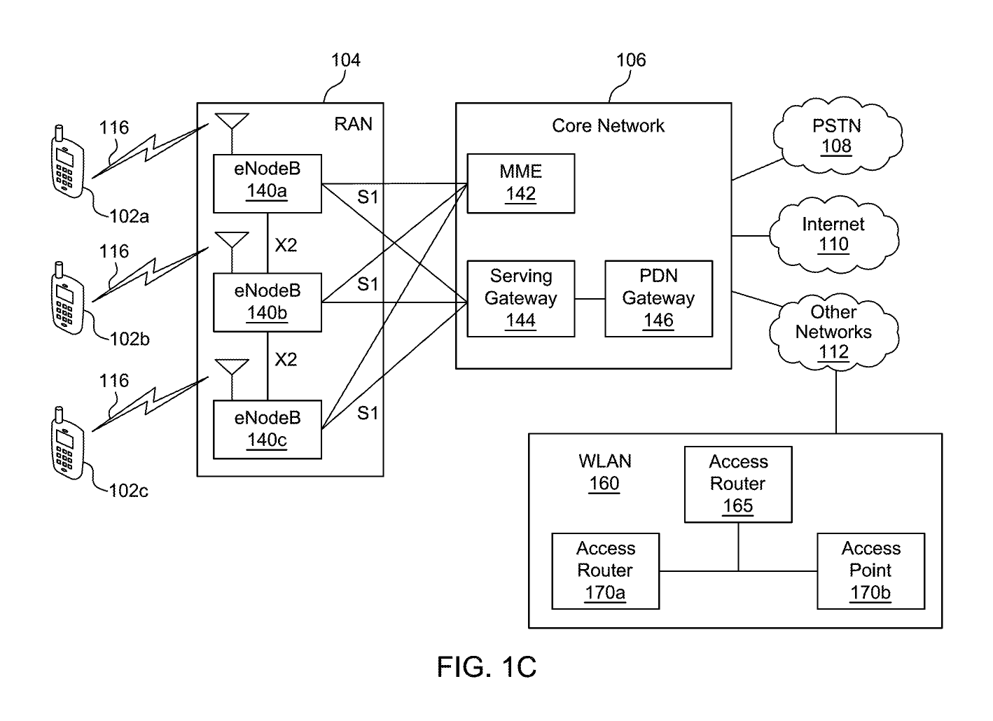

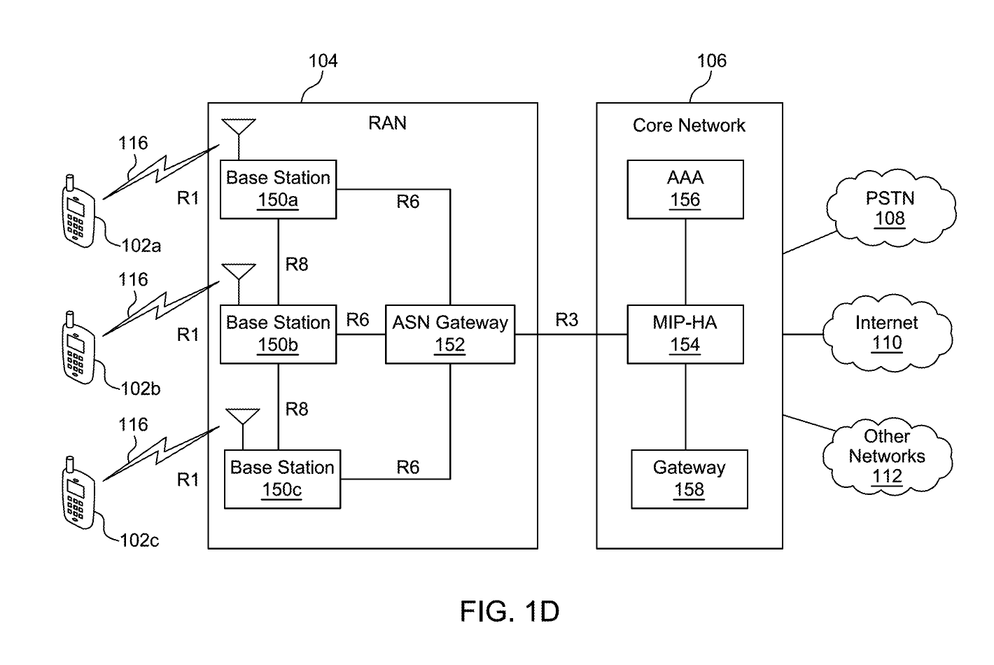

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency-division multiplexing (FDM), frequency-division multiple access (FDMA), orthogonal FDMA (OFDMA), single-carrier FDMA (SC-FDMA), and the like. Communication systems 100 may also utilize modulation techniques such as phase-shift keying (PSK), frequency-shift keying (FSK), amplitude-shift keying (ASK), on-off keying (OOK), quadrature amplitude modulation (QAM), continuous phase modulation (CPM), orthogonal frequency-division multiplexing (OFDM), or the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (W-CDMA). W-CDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., W-CDMA, CDMA2000, GSM, LTE, LTE-A, 3G, 4G, 5G, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an Si interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or W-CDMA.

The serving gateway 144 may be connected to each of the eNode Bs 140a, 140b, 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Other network 112 may further be connected to an IEEE 802.11 based wireless local area network (WLAN) 160. The WLAN 160 may include an access router 165. The access router may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a is in wireless communication over an air interface with WTRU 102d.

FIG. 1D is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1D, the RAN 104 may include base stations 150a, 150b, 150c, and an ASN gateway 152, though it will be appreciated that the RAN 104 may include any number of base stations and ASN gateways while remaining consistent with an embodiment. The base stations 150a, 150b, 150c may each be associated with a particular cell (not shown) in the RAN 104 and may each include one or more transceivers for communicating with the WTRUs 102a, 102b, 102c over the air interface 116. In one embodiment, the base stations 150a, 150b, 150c may implement MIMO technology. Thus, the base station 150a, for example, may use multiple antennas to transmit wireless signals to, and receive wireless signals from, the WTRU 102a. The base stations 150a, 150b, 150c may also provide mobility management functions, such as handoff triggering, tunnel establishment, radio resource management, traffic classification, quality of service (QoS) policy enforcement, and the like. The ASN gateway 152 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 150a, 150b, 150c may be defined as an R8 reference point that includes protocols for facilitating WTRU handovers and the transfer of data between base stations. The communication link between the base stations 150a, 150b, 150c and the ASN gateway 152 may be defined as an R6 reference point. The R6 reference point may include protocols for facilitating mobility management based on mobility events associated with each of the WTRUs 102a, 102b, 102c.

As shown in FIG. 1D, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 154, an authentication, authorization, accounting (AAA) server 156, and a gateway 158. While each of the foregoing elements are depicted as part of the core network 106, it will be appreciated that any one of these elements may be owned and/or operated by an entity other than the core network operator.

The MIP-HA 154 may be responsible for IP address management, and may enable the WTRUs 102a, 102b, 102c to roam between different ASNs and/or different core networks. The MIP-HA 154 may provide the WTRUs 102a, 102b, 102c with access to packet-switched networks, such as the Internet 110, to facilitate communications between the WTRUs 102a, 102b, 102c and IP-enabled devices. The AAA server 156 may be responsible for user authentication and for supporting user services. The gateway 158 may facilitate interworking with other networks. For example, the gateway 158 may provide the WTRUs 102a, 102b, 102c with access to circuit-switched networks, such as the PSTN 108, to facilitate communications between the WTRUs 102a, 102b, 102c and traditional land-line communications devices. In addition, the gateway 158 may provide the WTRUs 102a, 102b, 102c with access to the networks 112, which may include other wired or wireless networks that are owned and/or operated by other service providers.

Although not shown in FIG. 1D, it will be appreciated that the RAN 104 may be connected to other ASNs and the core network 106 may be connected to other core networks. The communication link between the RAN 104 and the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

In the examples given herewith, transmission by a network to WTRU 102 and reception by a WTRU 102 may be given. However, one of ordinary skill in the art appreciates and understands application of the examples with transmission from WTRU 102 to a network and reception by a network.

In OFDM, the DC carrier may be disabled to address distortion at zero frequency as a result of using direct conversion transceivers or transmitters. In addition, edge subcarriers in OFDM may be nulled to provide guard bands or mitigate adjacent channel interference (ACI) and transmit windowing may be used to smooth symbol transitions. However, extension of the effective symbol duration due to a slower transition may reduce spectral efficiency.

Moreover, time-asymmetric pulse shaping approaches may utilize a part of the cyclic prefix (CP) as a transition to maintain spectral efficiency while reducing out-of-band (OOB) emissions. An N-continuous OFDM signal is an example of a signal that may use shaping. Shaping may be achieved in a signal by filtering the OOB spectrum.

For N-continuos OFDM, small distortions may be added to data or control subcarriers at a transmitter, or as example at transceiver 120, such that consecutive symbols are substantially continuous up to N derivations. However, the created distortion may undesirably need a modified receiver(s) at WTRU 102 or base stations 114a or 114b or channel state information (CSI) to cancel distortion.

In the examples given herewith, N-continuous OFDM transmission at WTRU 102 or base stations 114a or 114b may be configured or altered with a varied degree or degrees of freedom in distortion of data or control subcarriers. An OFDM symbol(s) may include a first part with N_{d} subcarriers or samples, and a CP part with G_{d} samples. In addition to using a N_{d} size alignment or correction vector that corresponds to one alignment or correction component per subcarrier, a larger-size alignment or correction vector, such as N_{d}+G_{d}, may be used. In the frequency domain, this may correspond to using more points than the number of subcarriers in a signal for a distortion component.

Moreover, the alignment or correction component may be configured or generated, such as by WTRU 102 or base stations 114a or 114b, such that after passing through a wired or wireless channel the component may be substantially aligned to the CP duration or portion at a receiver (e.g., transceiver 120). This may prevent distortion on data or control carrying subcarriers or symbols while maintaining the benefits of N-continuous OFDM signals. Backwards computability may also be maintained since receiver modification may not be needed. In addition energy, power, or battery life may be saved at a receiver since iterative decoding or demodulation may not be needed to cancel interference.

At a receiver, such as at transceiver 120, the CP portion of a transmitted signal may be discarded or removed, substantially eliminating or reducing inter-symbol interference (ISI). Removal of the CP may provide up to or equal to G_{d} degrees of freedom at a transmitter or as example at transceiver 120 to align the alignment component into the CP duration or portion without substantially little impact on the data or control information duration. When generating an alignment component with a N-continuity signal, N+1 degrees of freedom may be needed. Other dimensions for an alignment component maybe utilized to reduce peak-to-average power ratio (PAPR) of the transmitted signal. For example, a CP-alignment component may utilize other dimensions to reduce the PAPR.

In the examples given herewith, matrices [columns vectors] are denoted with upper [lower] case boldface letters (e.g., A [a]). Superscripts T and H denote transpose, and conjugate transpose, respectively. In addition, x̅ denotes the conjugate of a scalar number x, j=\sqrt{−1} is the imaginary unit, and Eₓ[y(x)] denotes the expectation of y(x) over the random argument x. Lastly, ∥x∥_{∞} may denote the uniform norm (infinity norm) of vector x and

$$\frac{{d}^{n}}{{dt}^{n}}$$

is the n th derivative operator with respect to t.

A transmitted signal s over time t may be represented to include components

sᵢ(t)=xᵢ(t)+aᵢ(t). Equation (1)

where xᵢ(t) and aᵢ(t) may be the data and the alignment component for the i th symbol, respectively. The descriptions forthcoming provide examples of when data symbol xᵢ(t) may be an OFDM data symbol. However, the generation, creation, or transmission of data symbol xᵢ(t) similarly or equally apply to other wired or wireless modulation schemes. As an example, data symbol xᵢ(t) may be an FDM, FDMA, or SC-FDMA based symbol.

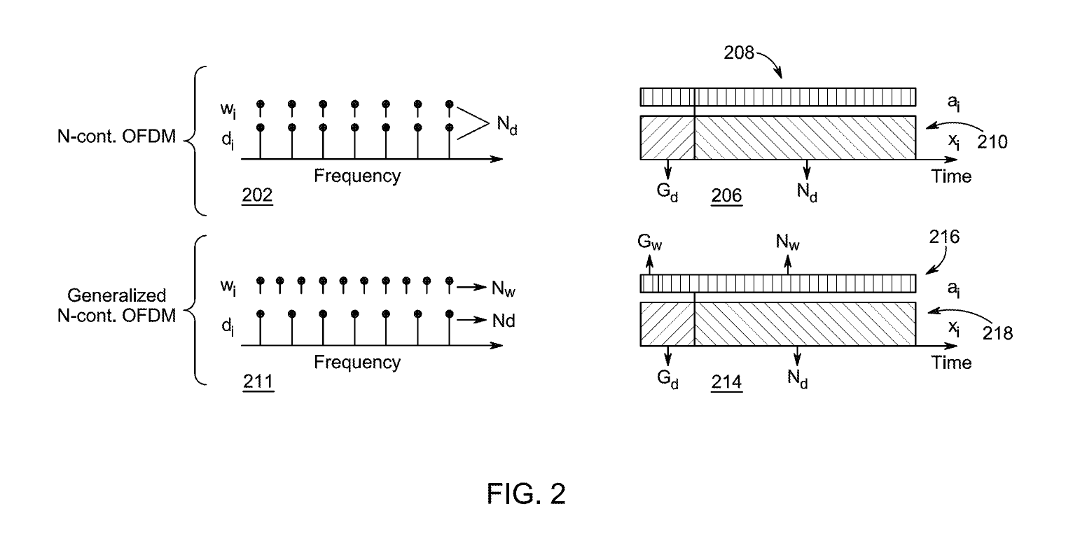

FIG. 2 shows graphs illustrating components of a transmitted signals 206 and 214. OFDM data symbol xᵢ(t) 210, with CP duration or portion equal to T_{g}, may be combined with an alignment component aᵢ(t) (208) with a random or arbitrary CP duration or portion. For spectral control of OOB leakage, alignment component 208 may be generated in the form of an OFDM signal which includes subcarriers with optimized alignment weights such that processing is performed at symbol transitions. For additional degrees of freedom, alignment component 208 may have smaller subcarrier spacing, i.e., larger symbol duration, compared to the data part. The complex envelope representations for OFDM data symbol 210 and alignment component 208 may be represented as

$$\begin{matrix} {x}_{i} ( t ) = \frac{1}{\sqrt{{N}_{d}}} {\sum }_{k ∈ {N}_{d}} {d}_{i , k} {e}^{j \frac{2 π k}{{T}_{d}} t} , - {T}_{g} \leq t < {T}_{d} , & Equation ( 2 ) \\ and & \\ {a}_{i} ( t ) = \frac{1}{\sqrt{{N}_{w}}} {\sum }_{l ∈ {N}_{w}} {w}_{i , l} {e}^{j \frac{2 π l}{{T}_{w}} ( t - ( {T}_{d} - {T}_{w} ) )} , - {T}_{g} \leq t < {T}_{d} & Equation ( 3 )\end{matrix}$$

where N_{d} and N_{w} are the number of OFDM subcarriers and the number of frequency bins for the alignment component, and N_{d} and N_{w} are corresponding subcarrier index sets, T_{d} is the data duration of OFDM transmitted signal sᵢ(t), T_{g} is the CP duration for OFDM signal sᵢ(t), and T_{w} is the main duration for the alignment component 208. The signal structure is illustrated in FIG. 2. Considering the consecutive symbols, the overall signal also may be represented as

$$s ( t ) = {\sum }_{i = 0}^{∞} {s}_{i} ( t - i ( {T}_{g} + {T}_{d} ) ) . \qquad Equation ( 4 )$$

A continuous time representation may be given for continuity at symbol boundaries with the help of an alignment component 208. Discrete time signals in which the signals may be represented may be defined in the frequency domain for both data component dᵢ and alignment component wᵢ as shown in graph 202 for N-cont. OFDM. Considering the OFDM formulation in equations (2) and (3), equation (1) may be rewritten in matrix form as

sᵢ=xᵢ+aᵢ=A_{d}F_{d}^{H}dᵢ+A_{w}F_{w}^{H}wᵢ Equation (5)

where dᵢ=└d_{i,-N}_{_{d}}_{/2}, . . . , d_{i,(N}_{_{d}}_{/2)-1}┘^{T}, wᵢ=└w_{i,-N}_{_{w}}_{/2}, . . . , w_{i,(N}_{_{w}}_{/2)-1}┘^{T}, F_{d}ϵC^{N}^{_{d}}^{×N}^{_{d}} and F_{w}ϵC^{N}^{_{w}}^{×N}^{_{w}} are N_{d}- and N_{w}-point discrete fourier transform (DFT) matrices for data and alignment components, respectively. Insertion of CP may be represented by

$${A}_{d} = [ \begin{matrix}{0}_{{G}_{d} \times ( {N}_{d} - {G}_{d} )} {I}_{{G}_{d}} \\ {I}_{{N}_{d}}\end{matrix} ] ∈ {C}^{( {N}_{d} + {G}_{d} ) \times {N}_{d}} , \\ {A}_{w} = [ \begin{matrix}{0}_{{G}_{w} \times ( {N}_{w} - {G}_{w} )} {I}_{{G}_{w}} \\ {I}_{{N}_{w}}\end{matrix} ] ∈ {C}^{( {N}_{w} + {G}_{w} ) \times {N}_{w}}$$

where G_{d} and G_{w} may be the CP sizes for the data and alignment components, respectively.

As shown in FIG. 2, symbol durations for both xᵢ(t) and aᵢ(t) may be substantially equal as N_{d}+G_{d}=N_{w}+G_{w}. Parameters for OFDM data symbol 210 may be determined with utilization of channel statistics, latency, spectral efficiency requirements, or the like as desired. Parameters for alignment component 208 or 216 may be determined with utilization of spectral shaping, PAPR reduction, CP-alignment, and secure transmission, or the like.

Transmitted signal sᵢ(t) may pass through a multipath fading or noisy channel. The multipath fading channel may be modeled by independent and identically distributed (IID) Rayleigh fading. A channel response between a transmitter and receiver may be represented by the vector h=[h₀, . . . , j_{L-1}] where L is the number of channel taps. The received signal for the ith symbol may be represented as:

$${r}_{i} = [ \begin{matrix}{H}_{p} & {H}_{c} ] [ \begin{matrix}{s}_{i - 1} \\ {s}_{i}\end{matrix} ] = {H}_{c} {s}_{i} + {H}_{p} {s}_{i - 1}\end{matrix} \qquad Equation ( 6 )$$

where H_{c}ϵC^{(N}^{_{d}}^{+G}^{_{d}}^{)×(N}^{_{d}}^{+G}^{_{d}}⁾ and HₚϵC^{(N}^{_{d}}^{+G}^{_{d}}⁾ may be Toeplitz matrices constructed by the channel response h, and may represent the convolution between transmitted signal sᵢ(t) and a channel. In particular,

$${H}_{c} = [ \begin{matrix}{h}_{0} & 0 & … & … & … & 0 \\ ⋮ & ⋱ & ⋱ & ⋱ & ⋱ & ⋮ \\ {h}_{L - 1} & … & {h}_{0} & ⋱ & ⋱ & ⋮ \\ 0 & ⋱ & ⋱ & ⋱ & ⋱ & ⋮ \\ ⋮ & ⋱ & ⋱ & ⋱ & ⋱ & 0 \\ 0 & … & 0 & {h}_{L - 1} & … & {h}_{0}\end{matrix} ] ,$$

may correspond to the portion that maps sᵢ to the receiving window for the i symbol, and

$${H}_{p} = [ \begin{matrix}0 & … & 0 & {h}_{L - 1} & … & {h}_{1} \\ ⋮ & ⋱ & ⋱ & ⋱ & ⋱ & ⋮ \\ ⋮ & ⋱ & ⋱ & ⋱ & ⋱ & {h}_{L - 1} \\ ⋮ & ⋱ & ⋱ & ⋱ & ⋱ & 0 \\ ⋮ & ⋱ & ⋱ & ⋱ & ⋱ & ⋮ \\ 0 & … & … & … & … & 0\end{matrix} ] ,$$

may denote the mapping from a previously transmitted symbol sᵢ₋₁ to the receiver window of current symbol. Thus, with equation (6) inter-symbol interference (ISI) falling into the CP duration or portion at a receiver component at WTRU 102 or base stations 114a or 114b may be modeled.

A receiver component at WTRU 102 or base stations 114a or 114b may discard a CP portion from a received vector and perform a DFT to convert a signal into the frequency domain by the following operation:

yᵢ=F_{d}Brᵢ=F_{d}BH_{c}sᵢ+F_{d}BHₚsᵢ₋₁ Equation (7)

where B=└0_{N}_{_{d}}_{×G}_{_{d}} I_{N}_{_{d}}┘ may denote the CP removal operation. By stemming from the structures of the B and Hₚ matrices, it may be shown that

BHₚ=0_{N}_{_{d}}_{×1}, Equation (8)

which may correspond to elimination of ISI components from a previous symbol with CP removal. In the frequency domain a received symbol may be represented as

yᵢ=F_{d}BH_{c}sᵢ. Equation (9)

For generalized N-continuity OFDM transmissions, alignment component aᵢ(t) 216 may have equality of the first N derivatives at a symbol boundary. In addition, as shown in OFDM data symbol 218, for generalized N-continuous OFDM transmissions, the number of subcarriers of alignment component N_{w} may be different or not equal to the number of data subcarriers N_{d}. Discrete time signals in which the signals may be represented may be defined in the frequency domain for both data component dᵢ and alignment component wᵢ as shown in graph 211 for generalized N-cont. OFDM.

N-continuity at a boundary between an (i−1)th and ith symbols may be represented via differential equations as:

$$\begin{matrix}\frac{{d}^{n}}{{dt}^{n}} {s}_{i} ( t ) {\vert}_{t = - {T}_{g}} = \frac{{d}^{n}}{{dt}^{n}} {s}_{i - 1} ( t ) {\vert}_{t = {T}_{d}} , & Equation ( 10 ) \\ \frac{{d}^{n}}{{dt}^{n}} ( {x}_{i} ( t ) + {a}_{i} ( t ) ) {\vert}_{t = - {T}_{g}} = \frac{{d}^{n}}{{dt}^{n}} ( {x}_{i - 1} ( t ) + {a}_{i - 1} ( t ) ) {\vert}_{t = {T}_{d}} , & Equation ( 11 )\end{matrix}$$

for n=0, . . . , N−1. The set of equations in equation (11) may be due to substitution of equation (1) into equation (10). By substitution of equations (2) and (3) into equation (11), and characterization of derivations may yield equation (12):

$$\frac{1}{\sqrt{{N}_{d}} {T}_{d}^{n}} {\sum }_{k ∈ {N}_{d}} {k}^{n} {d}_{i , k} {e}^{j {φ}_{d} k} + \frac{1}{\sqrt{{N}_{w}} {T}_{w}^{n}} {\sum }_{l ∈ {N}_{w}} {l}^{n} {w}_{i , l} {e}^{j {φ}_{w} l} = \frac{1}{\sqrt{{N}_{d}} {T}_{d}^{n}} {\sum }_{k ∈ {N}_{d}} {k}^{n} {d}_{i - 1 , k} + \frac{1}{\sqrt{{N}_{w}} {T}_{w}^{n}} {\sum }_{l ∈ {N}_{w}} {l}^{n} {w}_{i - 1 , l} , n = 0 , … , N \qquad Equation ( 12 )$$

In equation (12),

$${φ}_{d} = - 2 π \frac{{T}_{d}}{{T}_{g}} and {φ}_{w} = - 2 π \frac{{T}_{g} + {T}_{d}}{{T}_{w}}$$

may be a phase offset at the beginning of a symbol for each subcarrier of OFDM data symbol 218 and alignment component 216, respectively. A matrix equivalent form of the system of N+1 linear equations in equation (12) may be represented as:

$$K {Φ}_{d} {d}_{i} + L {Φ}_{w} {w}_{i} = {Kd}_{i - 1} + {Lw}_{i - 1} \\ where \\ {Φ}_{d} = diag ( {e}^{j {φ}_{d} {k}_{0}} , … , {e}^{j {φ}_{d} {k}_{{N}_{d} - 1}} ) ∈ {C}^{{N}_{d} \times {N}_{d}} \\ and \\ {Φ}_{w} = diag ( {e}^{j {φ}_{w} {k}_{0}} , … , {e}^{j {φ}_{w} {k}_{{N}_{w} - 1}} ) ∈ {C}^{{N}_{w} \times {N}_{w}} \qquad Equation ( 13 )$$

are diagonal matrices corresponding to the phase terms. In equation (13), matrices KϵR^{(N+1)×N}^{_{d}} and LϵR^{(N+1)×N}^{_{w}} may represent terms that are multiplied with OFDM data symbol 218 and alignment component 216, and may be defined as:

$$K = \frac{1}{\sqrt{{N}_{d}}} diag ( \frac{1}{{T}_{d}^{0}} , … , \frac{1}{{T}_{d}^{N}} ) [ \begin{matrix}1 & 1 & … & 1 \\ {k}_{0} & {k}_{1} & … & {k}_{{N}_{d} - 1} \\ ⋮ & ⋮ & ⋮ & ⋮ \\ {k}_{0}^{N} & {k}_{1}^{N} & … & {k}_{{N}_{d} - 1}^{N}\end{matrix} ]$$

$$and$$

$$L = \frac{1}{\sqrt{{N}_{w}}} diag ( \frac{1}{{T}_{w}^{0}} , … , \frac{1}{{T}_{w}^{N}} ) [ \begin{matrix}1 & 1 & … & 1 \\ {l}_{0} & {l}_{1} & … & {l}_{{N}_{w} - 1} \\ ⋮ & ⋮ & ⋮ & ⋮ \\ {l}_{0}^{N} & {l}_{1}^{N} & … & {l}_{{N}_{w} - 1}^{N}\end{matrix} ] .$$

The frequency domain alignment component wᵢ may satisfy

LΦ_{w}wᵢ=bᵢ Equation (14)

where bᵢ=−KΦ_{d}dᵢ+Kdᵢ₋₁+Lwᵢ₋₁, satisfies the N-continuity between the (i−1) th and i th symbols. Equation (14) may construct the basis for a generalized N-continuous OFDM signal where N_{w}≥N_{d}, i.e., the alignment component has more degrees of freedom than a data component.

The underdetermined system in equation (14) may have many or even up to an infinite number of solutions. In one example, for generalized N-continuity OFDM, wᵢ may only need to provide N-continuity. Thus, distortion of alignment component 216 on OFDM data symbol 218 may be minimized via a minimum-norm solution for wᵢ. Minimization may be achieved by the Moore-Penrose pseudoinverse of LΦ_{w}, (LΦ_{w})^{†}=Φ_{w}^{H}L^{H}(LL_{H})⁻¹. The minimum norm solution for alignment component 216 in the frequency domain may be represented as

wᵢ=Φ_{w}^{H}L^{H}(LL^{H})⁻¹bᵢ. Equation (15)

In an N-continuous OFDM configuration where N_{w}=N_{d}, each data subcarrier may have one correction or alignment component since data and alignment components may have substantially similar symbol and CP durations. When N_{w}=N_{d}, distortion may be created on data subcarriers even with a minimum norm solution.

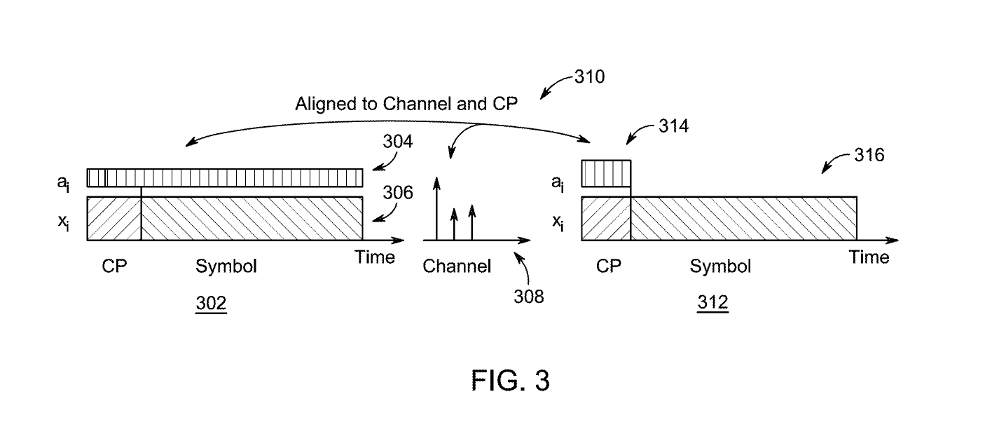

FIG. 3 shows a graph illustrating a cyclic prefix (CP) removal operation after transmission over a multipath channel. At transmit side 302, alignment component 304 may be combined with data symbol 306 to produce a signal for transmission sᵢ(t). On receive side 312, received data symbol 316 and alignment portion 314 may be received after transmission over multipath channel 308. When alignment component 304 has more degrees of freedom with N_{w}>N_{d}, it may be possible to cancel distortion caused by alignment component 304. This may be especially possible for OFDM implementations assuming bi-orthogonal transmission. A receiver component at WTRU 102 or base stations 114a or 114b may capture a subset of transmitted signal sᵢ(t) by removing CP portion of received data symbol 316. CP removal operation may reduce the number of dimensions at a receiver component at WTRU 102 or base stations 114a or 114b from N_{w} to N_{d}. By aligning the correction or alignment component with the CP duration or portion (310) at WTRU 102 or base stations 114a or 114b there may be substantially no-distortion in the communication.

Substitution of equation (5) into equation (9) yields the frequency domain received signal as

yᵢ=F_{d}BH_{c}A_{d}F_{d}^{H}dᵢ+F_{d}BH_{c}A_{w}F_{w}^{H}wᵢ Equation (16)

where the first term may be the desired data symbol vector, such as received data symbol 316, and the second term is the alignment portion 314 that falls into the FFT window for the i th symbol. In order to cancel alignment portion 314 of receive side 312, it may be necessary to satisfy

F_{d}BH_{c}A_{w}F_{w}^{H}wᵢ=0. Equation (17)

To satisfy equation (17), component wᵢ may need to be selected from the nullspace of F_{d}BH_{c}A_{w}F_{w}^{H}ϵC^{N}^{_{d}}^{×N}^{_{w}}. In order to enable cancelation of alignment portion 314 after channel and CP removal, a nonzero nullspace for the system represented by equation (17) may be needed.

From the rank-nullity theorem

dim(null(F_{d}BH_{c}A_{w}F_{w}^{H}))=N_{w}−rank(F_{d}BH_{c}A_{w}F_{w}^{H})=N_{w}−N_{d}. Equation (18)

Equation (18) may select a smaller CP size for alignment portion 314, i.e., N_{w}>N_{d}, and a non-injective system may be obtained in equation (17).

The solution space for equation (17) may be realized by:

wᵢ=Ptᵢ Equation (19)

where PϵC^{N}^{_{w}}^{×(N}^{_{w}}^{-N}^{_{d}}⁾ is a precoder matrix that maps an arbitrary vector tᵢϵC^{(N}^{_{w}}^{-N}^{_{d}}^{)×1} into the nullspace of F_{d}BH_{c}A_{w}F_{w}^{H}. In other words, the columns of P may span the nullspace as

range(P)=null(F_{d}BH_{c}A_{w}F_{w}^{H}), Equation (20)

and may be computed by singular value decomposition (SVD) as

F_{d}BH_{c}A_{w}F_{w}^{H}=UΣV^{H} Equation (21)

where UϵC^{N}^{_{d}}^{×N}^{_{d}} and VϵC^{N}^{_{w}}^{×N}^{_{d}} are orthonormal matrices and ΣϵC^{N}^{_{d}}^{×N}^{_{w}} is the diagonal matrix containing the singular values in decreasing order along its diagonal. Then, P may be found by importing the last N_{w}−N_{d} columns of V, represented as

P=└v_{N}_{_{d}}, . . . ,v_{N}_{_{w}}₋₁┘ Equation (22)

With waveform alignment and nullspace preconditioning for the additional or distortion component, substituting equation (19) into the main equation in equation (14) may yield

LΦ_{w}Ptᵢ=bᵢ Equation (23)

which may need to be satisfied in order for alignment component 304 to provide N-continuity and fall within CP portion at a receiver component at WTRU 102 or base stations 114a or 114b, substantially simultaneously, simultaneously, substantially concurrently, concurrently, or the like. A least squares solution for equation (23) may be selected similar to the previous case. Even though the effect on OFDM reception may be substantially canceled with waveform alignment, minimizing the norm of additional or distortion components may be desirable for energy management, power budgeting, or the like. A minimum-norm solution for tᵢ may be found by using the pseudoinverse of LΦ_{w}P as

tᵢ^{mn}=(LΦ_{w}P)^{†}bᵢ Equation (24)

which may be substituted into equation (19) to yield the frequency domain alignment component as

wᵢ=PP^{H}Φ_{w}^{H}L^{H}(LΦ_{w}PP^{H}Φ_{w}^{H}L^{H})⁻¹bᵢ Equation (25)

Utilizing the additional or distortion component for PAPR reduction may also be desirable. In the examples given for equations (14) and (23), the systems of linear equations may be underdetermined. Thus, there are many solutions and minimum length solutions to select in equations (15) and (25), respectively. Because any vector may be selected or utilized for tᵢ, alignment component 304 may provide various benefits on transmitted signal sᵢ(t). For instance, PAPR reduction may be considered for selection of a particular tᵢ rather than tᵢ^{min}.

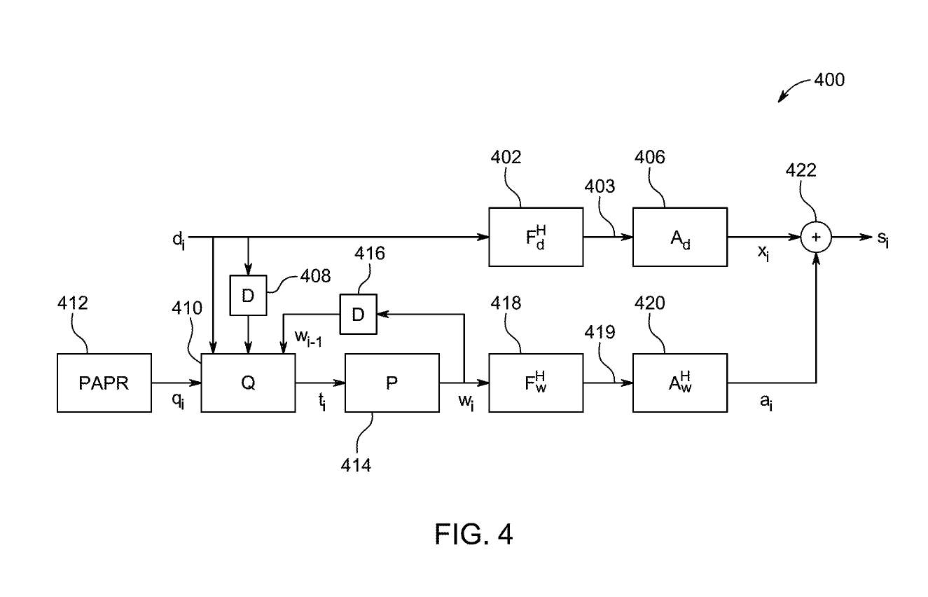

FIG. 4 is a block diagram of processing data or control information 400. Data or control information dᵢ may be processed by F_{d}^{H} inverse DFT (IDFT) component 402 to produce signal 403. Signal 403 may be processed by CP insertion component A_{d} 406 to produce data component xᵢ for the i th symbol.

Furthermore, PAPR unit 412 may provide free variable qᵢ to component Q 410 where QϵC^{(N}^{_{w}}^{-N}^{_{d}}^{)×((N}^{_{w}}^{-N}^{_{d}}^{-N-1))}. Data or control information dᵢ, dᵢ−1 produced by delay component 408, and wᵢ₋₁ (i.e., alignment component−1) produced by delay component 416 may be utilized by component Q 410 to produce solution vector tᵢ. The operation for precoding component 414 may be represented as PϵC^{N}^{_{w}}^{×(N}^{_{w}}^{-N}^{_{d}}⁾. Frequency domain alignment component wᵢ may be processed by F_{w}^{H} IDFT component 418 producing signal 419. Signal 419 may be processed by CP insertion component A_{w}^{H} 420 to produce alignment component aᵢ for the i th symbol. Transmitted signal sᵢ is generated by combining (422) data component xᵢ with alignment component aᵢ.

Referring again to solution vector tᵢ, an underdetermined system may be represented by a combination of a vector in the row space and a vector in its nullspace (ns). Accordingly, a solution for equation (23) may be written as

$${t}_{i}^{pa} = \underbrace{{t}_{i}^{mn}}_{row space \\ component} + \underbrace{{t}_{i}^{ns}}_{millspace \\ component} \qquad Equation ( 26 )$$

where the first component is the minimum norm (mn) solution laying in the row space of LΦ_{w}P as given in equation (24) and the second component is selected from the nullspace (ns) of LΦ_{w}P.

By considering the decomposition in equation (26), the equation (23) may be rewritten as

LΦ_{w}Ptᵢ^{pa}=LΦ_{w}Ptᵢ^{mn}+LΦ_{w}Ptᵢ^{ns}=bᵢ Equation (27)

which implies that LΦ_{w}Ptᵢ^{ns}=0. Similar to the approach for finding the nullspace component for CP-alignment described herein, e.g. with respect to equations (19)-(22), a nullspace vector that satisfies the N-continuity may be generated inside the nullspace of CP-alignment as

tᵢ^{ns}=Qq, Equation (28)

where QϵC^{(N}^{_{w}}^{-N}^{_{d}}^{)×((N}^{_{w}}^{-N}^{_{d}}^{-N-1))} satisfies

range(Q)=null(LΦ_{w}P), Equation (29)

and hence maps any arbitrary vector qᵢϵC^{(N}^{_{w}}^{-N}^{_{d}}^{-N-1)×1} into the nullspace of LΦ_{w}P. Columns of Q may be found via singular value decomposition (SVD) of LΦ_{w}P similar to the method in previous section.

Still referring to FIG. 4, free variable qᵢ may be optimized to minimize the PAPR of the i th transmitted symbol. Peak power of the transmitted signal may be represented by the infinite norm as ∥sᵢ∥_{∞}=∥xᵢ+aᵢ∥_{∞}. The frequency domain alignment vector then may be found as

$${w}_{i} = arg {min}_{q} {‖ {x}_{i} + {A}_{w} {F}_{w }^{H} P ( {t}_{i}^{ls} + {Qq}_{i} ) ‖}_{∞} \qquad Equation ( 30 )$$

which may make the overall signal N-continuous, the correction or alignment component aligned to the CP duration or portion at a receiver component at WTRU 102 or base stations 114a or 114b, and result in a reducation of PAPR.

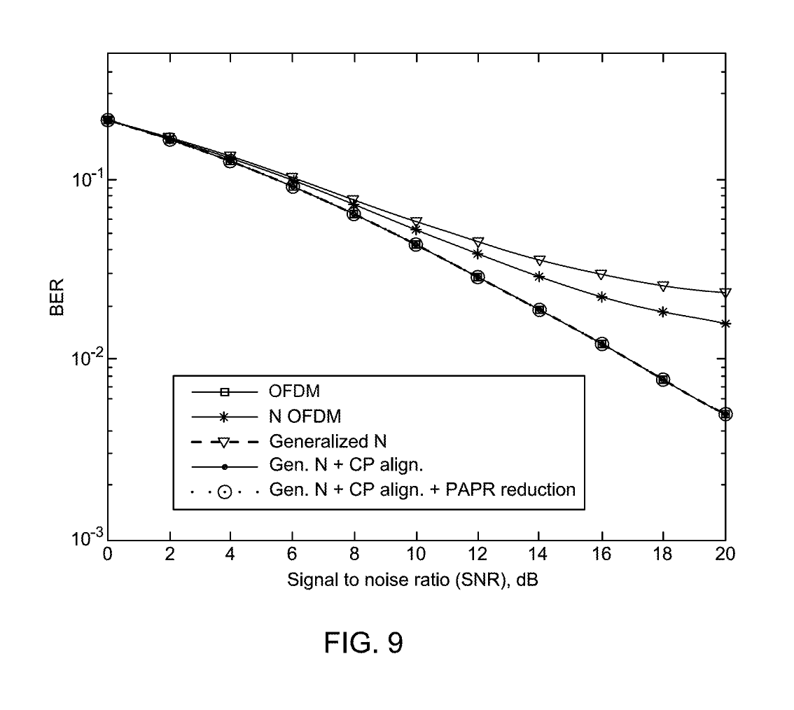

FIG. 9 shows an example of bit error rates (BER) for a hypothetical OFDM communication. For the results in FIG. 9, OFDM parameters may be N_{d}=300 subcarriers that are active with T_{d}=1/15 milliseconds (ms) where T_{g}=1/4T_{d}. For the results in FIG. 9, the direct current (DC) subcarrier may be disabled. The duration of the data part of the alignment component that excludes the CP may be selected as T_{w}=9/8T_{d}. In addition, for backwards compatibility an unmodified OFDM receiver at WTRU 102 or base stations 114a or 114b may be utilized for results shown in FIG. 9. As explained herewith, with or without PAPR reduction, utilizing an unmodified OFDM receiver may be possible due to a substantially aligned correction or alignment component.

As shown in FIG. 9, OFDM, N-continuous OFDM, or generalized N-continuous OFDM communications without PAPR reduction may have substantially similar PAPR performance up to a certain signal to noise ratio. With PAPR reduction, there there may be a substantial gain in peak power statistics for N-continuous OFDM. Both N-continuous OFDM and generalized N-continuous OFDM may have interference caused by an alignment component that may need a decision feedback mechanism. For a generalized N-continuous transmission, if initially the CP is not aligned, there may be less interference due to the alignment component. This may be due to larger number of free variables in a generalized N-continuous transmission that may achieve continuity with less distortion in data symbol 316.

Similar to alignment components 208 and 216 in FIG. 2 or alignment component 304 in FIG. 3, a suppressing signal may be generated to utilize both the CP duration or portion of FDM, FDMA, SC-FDMA, OFDM or OFDMA symbols and non-utilized subcarriers at a receiver component at WTRU 102 or base stations 114a or 114b. Alignment of information may be applied for transmission of the suppressing signal in multiple user and multiple antenna device (e.g. MIMO) configurations to reduce OOB leakage and PAPR of OFDM or OFDMA symbols.

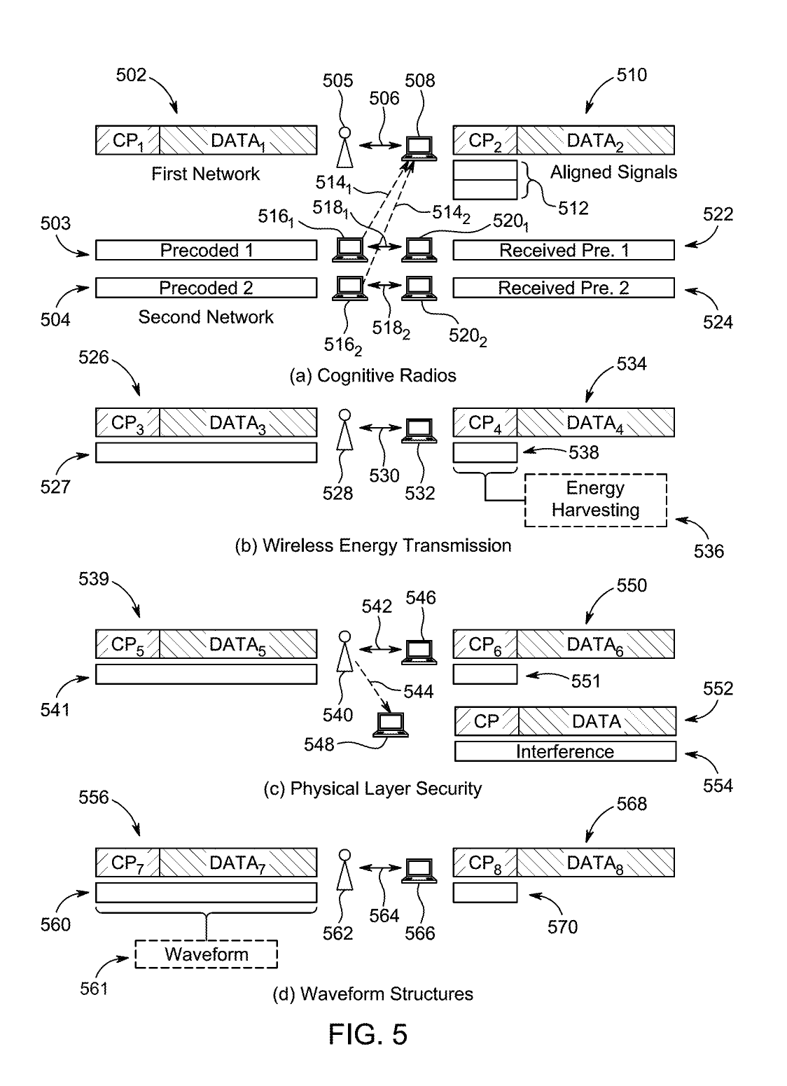

FIG. 5 is an illustration of communicating alignment components with a CP duration or portion. In certain examples of FIG. 5, interference alignment may be needed when a transmitted signal undergoes a change after it passes through channels 506, 530, 542, or 564 so that each WTRU 508, 532, 546, or 566 has a different perception of transmitted symbols. For cognitive radio environments, if channel state information (CSI) between secondary WTRUs 516₁, 516₂, 520₁, and 520₂ of the second network and primary WTRU 508 of the first network are available to the secondary WTRUs, transmissions in the second network may be configured such that interference may be substantially concentrated at the CP part of symbols (e.g, FDM, FDMA, SC-FDMA, OFDM or OFDMA symbols) and non-utilized subcarriers at a corresponding primary WTRU or other primary WTRUs. However, in certain configurations, a precoder may be needed for secondary WTRUs to assist with interference alignment.

For cognitive radio interference alignment, first and second networks may operate in a same region or area. The first and second networks may be independent or logical entities of the same network. Base station 505 in a first network may serve multiple WTRUs, including primary WTRU 508, by using a multiple access scheme such as OFDMA and redundancy (e.g., CP duration). Base station 505, which may be configured as base stations 114a or 114b, may communicate information 502 that includes CP₁ and DATA₁.

Secondary WTRUs 516₁, 516₂, 520₁, and 520₂ in a second network may utilize substantially the same spectrum as the first network to communicate precoded information 1 (503) or precoded information 2 (504) via communication links 518₁ and 518₂, respectively. The second network may coexist with the first network and utilize an interference alignment scheme such that interfering signals 514₁ and 514₂, received as precoded information 1 (522) and precoded information 2 (524), are aligned (512) with the redundant parts of received transmission signal 510 of the first network that includes CP₂ and DATA₂. In this configuration, a second network may communicate substantially free of co-channel interference while allowing the first network to remain unchanged with interference alignment.

Principles of cognitive interference alignment given herewith may also apply to wireless energy transfer. Base station 528, which may configured as base stations 114a, 114b, may transmit OFDM based information 526 that includes CP₃ and DATA₃. Alignment or suppressing signal 527 may be generated such that it is aligned with the CP duration or portion 538 of received OFDM information 534 that includes CP₄ and DATA₄ at a receiver component at WTRU 532. The energy level at CP duration or portion 538 may be boosted such that it yields extra energy that may be extracted by energy harvesting units 536 at WTRU 102 or base stations 114a or 114b. For wireless energy transfer, alignment or suppressing signal 527 may be random, substantially random, or partially random and seen as noise to WTRU 532. To reduce undesirable waveforms properties such as OOB and PAPR for communications between base station 528 and WTRU 532, alignment or suppressing signal 527 may be altered such that OOB or PAPR is reduced.

Still referring to FIG. 5, for physical layer security applications of suppressing signal communications, randomness of multipath or uniqueness of channel 542 may be utilized to increase secrecy capacity between base station 540 and WTRU 546 of communication 539. In this configuration, instantaneous channel characteristics may be specific or unique between base station 540 and WTRU 546. A suppressing or alignment signal may be generated based on the specific or unique channel characteristics. Since channel characteristics between base station 540 and WTRU 548 or to other receivers may be different than the channel to WTRU 546, the suppressing or alignment signal may be seen as noise to WTRU 548 making decoding of communication 539 substantially difficult.

Suppressing signal 541 may be combined with communication 539, that includes CP₅ and DATA₅, as explained herewith to be aligned with the CP duration or portion 551 of received communication 550 that includes CP₆ and DATA₆. In addition, unintended WTRUs, such as unintended receiver or eavesdropper WTRU 548, may see the combined communication as noise 544 or interference information 554 when receiving communication 552 keeping received communication 550 between base station 540 and WTRU 546 secure.

Similar to wireless energy transfer, to reduce undesirable waveforms properties such as OOB and PAPR for communications between base station 540 and WTRU 546, suppressing signal 541 may be altered such that OOB or PAPR is reduced while using existing hardware without substantial modification. To achieve this, waveform 561 may be generated using processing of data or control information 400 as alignment component 560. Alignment component 560 may be combined with information 556 that includes CP₇ and DATA₇ by base station 562 such that it is aligned with CP duration or portion 570 on reception of information 568. Information 568 includes CP₈ and DATA₈.

Multi-stream suppressing alignment may be used to mitigate OOB emission or PAPR of an accessing signal for substantially simultaneous communications for many-to-one, one-to-many, and many-to-many stream transmissions. For multi-stream suppressing alignment large degrees-of-freedom may be utilized due to different channels between WTRUs or WTRUs and base stations 114a or 114b. Large degrees of freedom may also provide desirable spectral shapes, peak power statistics, and robustness-to-channel dispersion.

Multi-stream suppressing alignment may utilize different perceptions of transmitters and receivers between WTRUs and WTRUs and base stations 114a or 114b on the redundancies of accessing signals to achieve desired waveform or signal characteristics. For instance, non-utilized portions of transmissions or signals at receivers may be used. While the effect of modification may be aligned with the space that is not utilized by the receivers, the multi-stream suppressing signals may cancel each other on the parts that are utilized by communication devices. This may result in using existing hardware at WTRU 102 or base stations 114a or 114b without substantial modification and providing backward compatibility.

Multi-stream suppressing signal configurations may also utilize different regions or zones to differentiate unintended and intended WTRUs for communications. As explained herewith, zones may be used such that the energy of the suppressing signals in the public region or zone may be limited. This may be desirable for multicasting or broadcasting information.

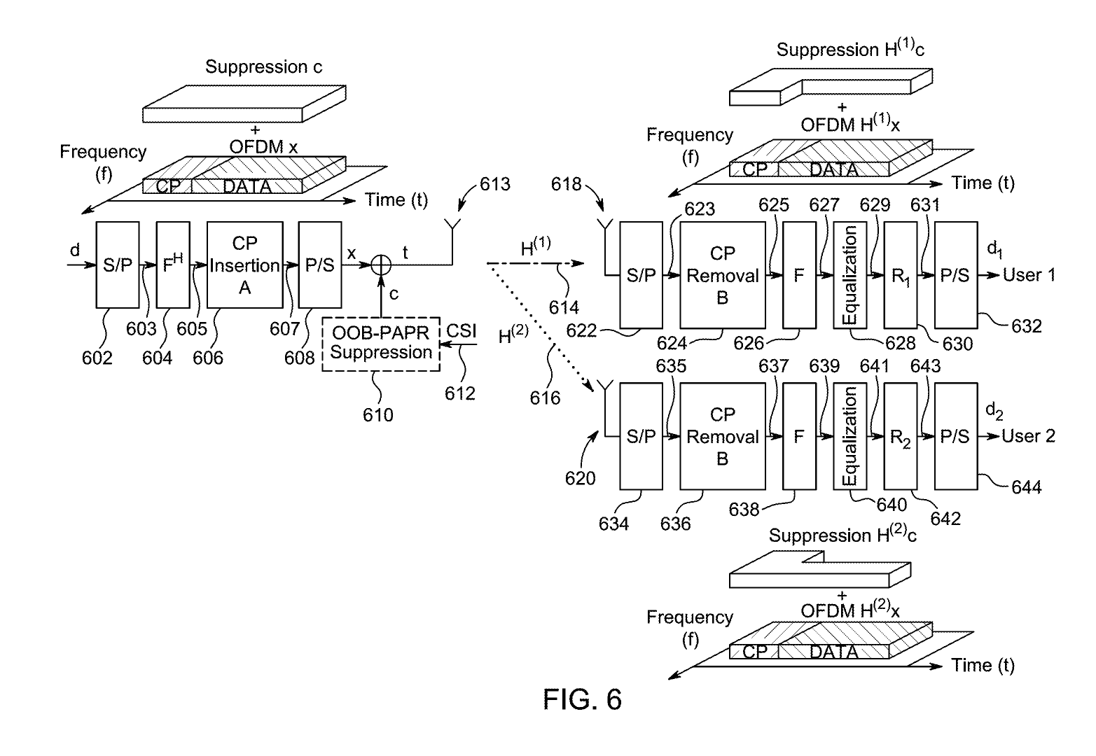

FIG. 6 is an illustration of suppressing alignment for multiple WTRUs that may utilize CSI. In FIG. 6, one of skill in the art will appreciate that data d may be selectively processed with a subset of the given components. Data d is serial-to-parallel (S/P) converted by component 602 to produce signal 603 that is processed by IDFT component 604 to produce signal 605. As provided in the forthcoming description, CP insertion block A component 606 produces signal 607 based on signal 605. Parallel-to-serial (P/S) component 608 produces data symbol x to be combined with suppressing signal c to produce transmitted signal t that is transmitted via antenna 613 as streams 614 and 616. As provided in the forthcoming description, CSI 612 may be utilized by OOB-PAPR suppression component 610 to produce suppressing signal c.

The channel response for stream 614 may be represented by H⁽¹⁾ and the channel response for stream 616 may be represented by H⁽²⁾. Stream 614 is received by antenna 618 and subsequently S/P converted by component 622 to produce signal 623. CP removal B component 624 removes the CP from signal 623 to produce signal 625 that is processed by DFT component 626 to produce signal 627. Signal 627 may be equalized by component 628 to produce signal 629. As provided in the forthcoming description, subcarrier selection R₁ component 630 selects data for User 1 from signal 629 to produce signal 631 that is P/S converted by component 632 to produce data output d₁.

Similarly, for User 2 stream 616 is received by antenna 620 and subsequently S/P converted by component 634 to produce signal 635. CP removal B component 636 removes the CP from signal 635 to produce signal 637 that is processed by DFT component 638 to produce signal 639. Signal 639 may be equalized by component 640 to produce signal 641. As provided in the forthcoming description, subcarrier selection R2 component 642 selects data for User 2 from signal 641 to produce signal 643 that is P/S converted by component 644 to produce data output d₂.

Transmitted signal t may be an OFDMA communication. An OFDMA communication may be provided to multiple receivers over a Rayleigh multipath channel. The number of receivers in a single OFDMA symbol and the number of subcarriers may be S and N, respectively. The receivers in a single OFDMA symbol may be indexed and stored in the set S where S=[1, 2, . . . , i, . . . , S]. While non-utilized subcarriers may be disabled, active subcarriers may be modulated by a set of QAM symbols and populated in vector dϵCN×1. To maintain the circular convolution at the receivers, a CP of length G samples, which may be assumed to be larger than the maximum delay spread of the channel, may be appended to the beginning of each OFDMA symbol. The time domain OFDMA signal may then be expressed in vectorized form as

x=AF^{H}d, Equation (31)

where F may be the N-point DFT matrix, and AϵR^{N+G×N} may be the CP insertion matrix defined as

$$A {=}^{△} [ \begin{matrix}{0}_{GxN - G} {I}_{G} \\ {I}_{N}\end{matrix} ] . \qquad Equation ( 32 )$$

To manage OOB emissions and PAPR of transmitted signal t, OOB-PAPR suppression component 610 may generate the time-domain suppressing signal cϵCN+G×1 with a substantially similar length as the OFDMA symbol. The transmitted signal t may be represented as

t=x+c=AF^{H}d+c. Equation (33)

where configuring suppressing signal c may be desirable.

The channel impulse response (CIR) between the transmitter and ith receiver may be expressed as the vector h⁽ⁱ⁾=[hᵢ₀, hᵢ₁, . . . , hᵢₗ]. The signal at the ith receiver may be represented as

$${r}^{( i )} = {H}^{( i )} t + {H}_{p}^{( i )} {t}_{p} , + {n}^{( i )} = {H}^{( i )} {AF}^{H} d + {H}^{( i )} c + {H}_{p}^{( i )} {t}_{p} , + {n}^{( i )} , \qquad Equation ( 34 )$$

where n⁽ⁱ⁾ϵC^{N+G×1}˜CN (0, σ²I_{N+G}) may be an additive white Gaussian noise (AWGN) vector, H⁽ⁱ⁾ϵC^{N+G×N+G} may be the convolution matrix used to model the interaction between the transmitted signal t and the channel h⁽ⁱ⁾, tₚ may be the previous OFDM symbol, and Hₚ⁽ⁱ⁾ϵC^{N+G×N+G} may be a matrix that characterizes the leakage from the previous symbol due to a multipath channel. Explicitly, H⁽ⁱ⁾ and Hₚ⁽ⁱ⁾ are represented as

$$\begin{matrix}{H}^{( i )} = [ \begin{matrix}{h}_{io} & 0 & … & … & … & … & … & 0 \\ {h}_{i 1} & {h}_{i 0} & 0 & ⋱ & ⋱ & ⋱ & ⋱ & ⋮ \\ ⋮ & ⋱ & ⋱ & ⋱ & ⋱ & ⋱ & ⋱ & ⋮ \\ ⋮ & ⋮ & ⋮ & ⋮ & ⋮ & ⋮ & ⋮ & ⋮ \\ ⋮ & ⋱ & ⋱ & ⋱ & ⋱ & ⋱ & ⋱ & 0 \\ 0 & … & … & 0 & {h}_{i 𝓁} & … & {h}_{i 1} & {h}_{i 0}\end{matrix} ] & Equation ( 35 ) \\ and & \\ {H}_{p}^{( i )} = [ \begin{matrix}0 & … & 0 & {h}_{i 𝓁} & … & {h}_{i 1} \\ 0 & ⋱ & ⋱ & ⋱ & ⋱ & ⋮ \\ ⋮ & ⋱ & ⋱ & ⋱ & ⋱ & {h}_{i 𝓁} \\ ⋮ & ⋱ & ⋱ & ⋱ & ⋱ & 0 \\ 0 & … & … & … & … & ⋮\end{matrix} ] & Equation ( 36 )\end{matrix}$$

respectively. Assuming synchronization and after S/P conversion by component 622, a receiver component, such as at WTRU 102 or base stations 114a or 114b, may be capable of removing the first G samples and then applying a DFT operation. Using equation (34), the received signal after CP removal and DFT operation, also represented as signal 627, may be represented as

$${\overline{d}}^{( i )} = {FBr}^{( i )} = {FBH}^{( i )} {AF}^{H} d + {FBH}^{( i )} c + {FBH}_{p}^{( i )} {t}_{p} , + \underbrace{{FBN}^{( i )}}_{{\overline{n}}^{( i )}} \qquad Equation ( 37 )$$

where n̅⁽ⁱ⁾ϵC^{N+G×1} may be the noise vector obtained after removing the first G samples from N and applying the DFT, and B may be the CP removal matrix which may be defined as

BΔ[0_{N×G}I_{N}]. Equation (38)

If CP duration is larger than the maximum delay spread of the channel, there will be little inter-symbol interference (ISI) at a receiver component, such as at WTRU 102 or base stations 114a or 114b. Therefore, the third term of equation (37) may be equal to zero. An ith receiver may extract its own data by selecting the entries of d̅⁽ⁱ⁾ as

$${\tilde{d}}^{( i )} = {R}^{( i )} {\overline{d}}^{( i )} = \underbrace{{R}^{( i )} {FBH}^{( i )} AFd}_{data} + \underbrace{{R}^{( i )} {FBH}^{( i )} c}_{interference} + \underbrace{{R}^{( i )} {\overline{n}}^{( i )}}_{noise} , \qquad Equation ( 39 )$$

where R⁽ⁱ⁾ϵR^{M}^{ᵢ}^{×N} may be the subcarrier selection matrix which represents the subcarriers belonging to ith receiver and Mᵢ may be the number of subcarriers assigned to ith receiver. Suppressing signal c may be determined such that interference caused by the added suppressing signal should be substantially zero at receivers of User 1 and User 2. By examining equation (39), the following may be needed for the receivers:

R⁽ⁱ⁾FBH⁽ⁱ⁾c=0∀iϵS. Equation (40)

If equation (40) is satisfied, a received vector \tilde{d}⁽ⁱ⁾ in equation (39) becomes similar to legacy OFDMA received data. In addition, an ith receiver may be able to apply equalization component 628 (e.g., single-tap) to recover information symbols. Modulation symbols in the vector \tilde{d}⁽ⁱ⁾ may experience substantially small or zero interference from suppressing signal c.

With CSI 612, to minimize the OOB leakage power and PAPR a suppressing signal may be determined by

$$c = {arg}_{{c}^{′}}^{min} ( 1 - λ ) {‖ {F}_{OOB} ( x + {c}^{′} ) ‖}_{2} + λ {‖ ( x + {c}^{′} ) ‖}_{∞} \\ over {c}^{′} ∈ {C}^{N + G \times 1} \\ subject to {R}^{( i )} {FBH}^{( i )} {c}^{′} = 0 ∀ i ∈ S , \\ {‖ {c}^{′} ‖}_{2} \leq \sqrt{α} {‖ x ‖}_{2} \qquad Equation ( 41 )$$

where F_{OOB} may be a matrix that extracts the spectral components of the signal in the OOB region, and a may be a parameter that limits power consumed by suppressing signal c as a fraction of OFDM signal power. Furthermore, λϵ[0, 1] may be a weighting factor that adjusts an objective function toward OOB leakage or PAPR reduction processes. For example, when λ=0, the objective function turns into an OOB power leakage reduction process. Furthermore, when λ=1, equation (41) may be a PAPR reduction process.

In equation (41), the number of constraints that may allow suppressing signal c to be aligned at the receivers may be substantially or directly proportional to the number of receivers to be supported in at least one OFDMA symbol. Thus, the number of constraints may be substantially high depending on the resource allocation scheme. To reduce the number of constraints, identification of a solution space for suppressing signal c may be desirable. A constraint matrix M may be represented as

$$M {=}^{△} [ \begin{matrix}{R}^{( 1 )} {FBH}^{( 1 )} \\ {R}^{( 2 )} {FBH}^{( 2 )} \\ ⋮ \\ {R}^{( S )} {FBH}^{( S )}\end{matrix} ] . \qquad Equation ( 42 )$$

The feasible region of equation (41) should satisfy the constraint of Mc′=0. This constraint may result in suppressing signal c existing in the null space of M, i.e., ker(M). Let EϵC^{N+G×D} be a matrix where its columns span ker(M), and D may be the degrees-of-freedom (DoF) available for the design of suppressing signal c, i.e., dim(ker(M)). Since R(E) corresponds to the feasible region, the solution of equation (41) may lie on R(E). Therefore, we may express suppressing signal c as a linear combination of the columns of E (i.e., c=Es where sϵC^{D×1}). To optimize equation (41), the following operation may be needed

$$s = {arg}_{{s}^{′}}^{min} ( 1 - λ ) {‖ {F}_{OOB} ( x + {Es}^{′} ) ‖}_{2} + λ {‖ ( x + {Es}^{′} ) ‖}_{∞} \\ over {s}^{′} ∈ {C}^{D \times 1} \\ subject to {‖ {Es}^{′} ‖}_{2} \leq \sqrt{α} {‖ x ‖}_{2} . \qquad Equation ( 43 )$$

The objective function and the constraint in equation (43) may be convex. Convex optimization may be solved numerically by a solver such as CVX and YALMIP as desired.

CSI of intended receivers at the transmitter may be needed to determine a suppressing signal. Otherwise, an unintended receiver may experience interference due to the suppressing signal. However, it may be desirable to have an OFDMA signal that can be utilized by intended WTRUs and WTRUs with or without CSI. Public region and private region zone may be utilized to support this configuration as desired.

A public region or zone may include subcarriers that a public or unintended receiver or WTRU may receive. In the public region or zone, a suppressing signal may be transmitted with the assumption that a receiver or WTRU has no CSI. A private region or zone may have subcarriers that a private (intended) receiver or WTRU may receive data on without interference where CSI may be available at a transmitter.

To reduce interference, the energy of the suppressing signal may be limited in the public region or zone. A suppressing signal that minimizes the OOB and PAPR of the signal while decreasing the energy in the public region or zone may be achieved by optimizing

$$s = {arg}_{{s}^{′}}^{min} {c}_{1} {‖ {F}_{OOB} ( x + {Es}^{′} ) ‖}_{2} + {c}_{2} {‖ ( x + {Es}^{′} ) ‖}_{∞} + {c}_{3} {‖ {F}_{public} ( {Es}^{′} ) ‖}_{2} \\ over {s}^{′} ∈ {C}^{D \times 1} \\ subject to {‖ {Es}^{′} ‖}_{2} \leq \sqrt{∝} {‖ x ‖}_{2} , \qquad Equation ( 44 )$$

where F_{public} is a matrix that gives the spectral contents of its domain in the public region or zone. Variables c₁, c₂, and c₃ correspond to weighting factors to generate a suppressing signal that minimizes OOB, PAPR, and interference. The third part of the objective function may allow minimization of the suppressing signal power in the public region or zone. Since a suppressing signal in the public region or zone may generate undesirable OOB leakage power and PAPR of the signal, the objective function in equation (44) may be desirable. Considering the weighting factors in equation (43), the coefficients may be expressed as c₁=1−λ−γ, c₂=λ, and c₃=γ. This choice extends equation (43) to (44) by applying similar weights for the l₂-norm and the infinite norm. For example, when γ=0, the objective function turns into a joint OOB power leakage and PAPR reduction problem and equation (43) is equivalent to equation (44).

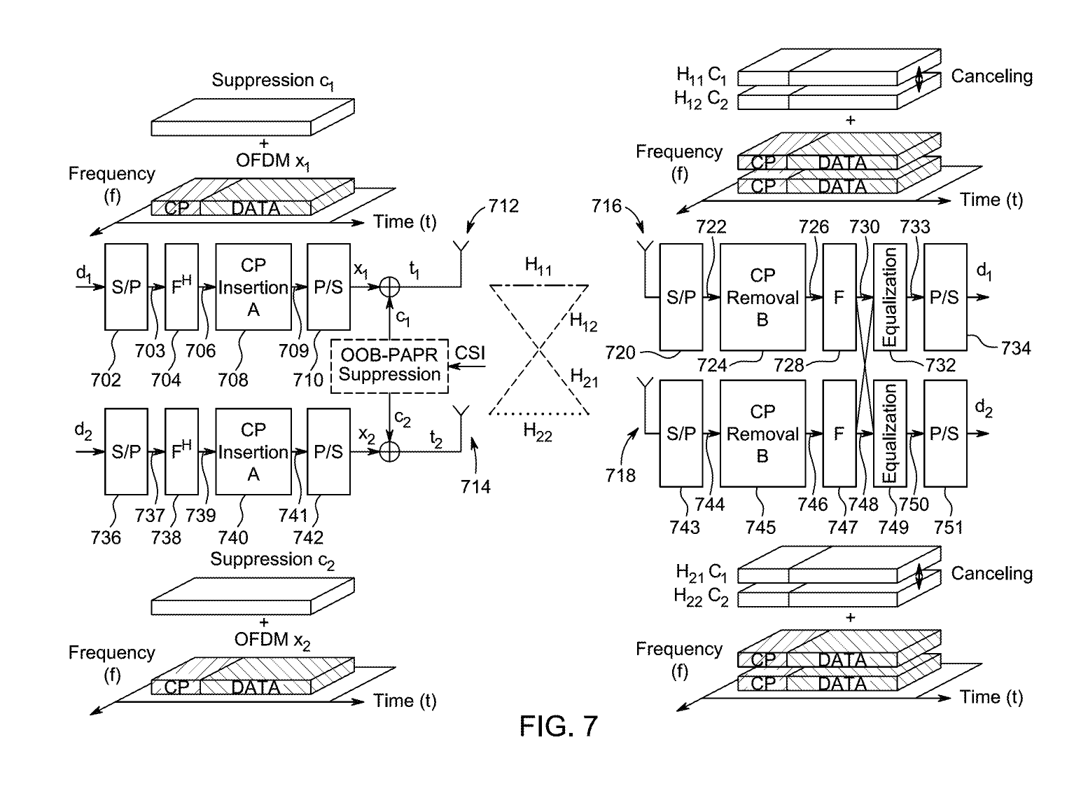

FIG. 7 is an illustration of MIMO alignment for a single WTRU that may utilize CSI. In FIG. 7, one of skill in the art will appreciate that data d₁ or d₂ may be selectively processed with a subset of the given components. A WTRU, such as WTRU 102, may have any number of K antennas and may be communicating over multipath fading channels with a receiver with any number of M antennas. As an example, M and K may equal 2. Data d₁ is S/P converted by component 702 to produce signal 703 that is processed by IDFT component 704 to produce signal 706. As explained herewith, CP insertion block A component 708 produces signal 709 based on signal 706. P/S component 710 produces data symbol x₁ to be combined with suppressing signal c₁ to produce transmitted signal t₁ that is transmitted via antenna 712. As explained herewith, CSI information may be utilized by an OOB-PAPR suppression component to produce suppressing signals c₁.

Data d₂ is S/P converted by component 736 to produce signal 737 that is processed by IDFT component 738 to produce signal 739. As explained herewith, CP insertion block A component 740 produces signal 741 based on signal 739. P/S component 742 produces data symbol x₂ to be combined with suppressing signal c₂ to produce transmitted signal t₂ that is transmitted via antenna 714. As explained herewith, CSI information may be utilized by an OOB-PAPR suppression component to produce suppressing signals c₂.

Transmitted signals t₁ is received by antenna 716 and subsequently S/P converted by component 720 to produce signal 722. CP removal B component 724 removes the CP from signal 722 to produce signal 726 that is processed by DFT component 728 to produce signal 730. Signal 730 may be equalized by component 732 to produce signal 733. Signal 733 is P/S converted by component 734 to produce data output d₁.

Transmitted signals t₂ is received by antenna 718 and subsequently S/P converted by component 743 to produce signal 744. CP removal B component 745 removes the CP from signal 744 to produce signal 746 that is processed by DFT component 747 to produce signal 748. Signal 748 may be equalized by component 749 to produce signal 750. Signal 750 is P/S converted by component 751 to produce data output d₂.

In the case for an OFDMA transmission for FIG. 7, OFDMA symbol transmitted from kth antenna may be represented as

xₖ=AF^{H}dₖ, Equation (45)

where dₖϵC^{N×1} is the data vector that includes symbols to be transmitted from kth transmit antenna. Similar to the generation of the signal given in equation (33) for single antenna transmissions, the suppressing signal may be generated for each transmit antenna and added to an OFDMA symbol as

tₖ=xₖ+cₖ=AF^{H}dₖ+Cₖ. Equation (46)

With synchronization between the transmitter and the ith receiver, the received signal, after CP removal B component 724 and DFT operation by DFT component 728, may be represented as

$${\overline{d}}_{m}^{( i )} = {FBr}^{( i )} = {\sum }_{k = 1}^{K} {FBH}_{mk}^{( i )} {t}_{k} + {\overline{n}}_{m}^{( i )} = {\sum }_{k = 1}^{K} {FBH}_{mk}^{( i )} {AF}^{H} {d}_{k} + {\sum }_{k = 1}^{K} {FBH}_{mk}^{( i )} {c}_{k} + {\overline{n}}_{m}^{( i )} , \qquad Equation ( 47 )$$

where Hₘₖ⁽ⁱ⁾ϵC^{N+G×N+G} is the convolution matrix due the multipath channel between the kth transmit antenna and the mth receive antenna and n̅ₘ⁽ⁱ⁾ϵ C^{N×1} is the noise vector in frequency for the mth receive antenna. Then, data belonging to the ith WTRU may be obtained by selecting the elements of d̅ₘ⁽ⁱ⁾ via the R⁽ⁱ⁾ matrix as

$${\tilde{d}}_{m}^{( i )} = {R}^{( i )} {\overline{d}}_{m}^{( i )} = \underbrace{{\sum }_{k = 1}^{K} {R}^{( i )} {FBH}_{mk}^{( i )} {AFd}_{m}}_{data} + \underbrace{{\sum }_{k = 1}^{K} {R}^{( i )} {FBH}_{mk}^{( i )} {c}_{k}}_{interference} + \underbrace{{R}^{( i )} {\overline{n}}_{m}^{( i )}}_{noise} . \qquad Equation ( 48 )$$

Low or substantially zero interference caused by a suppressing signal at the receiver side may need the following condition for the mth receive antenna of the ith receiver:

Σₖ₌₁^{K}R⁽ⁱ⁾FBHₘₖ⁽ⁱ⁾cₖ=0∀i|ϵS, Equation (49)

which generalizes the condition given in equation (10) from single antenna to multiple antennas.

R⁽ⁱ⁾ in equation (49) may become an identity matrix as all subcarriers belong to a single WTRU. Since the multiplication of a full rank matrix with a vector yields zero if and only if the vector is the zero vector, R⁽ⁱ⁾ and F may be removed from the condition given in equation (49). The reduced condition for the mth receive antenna is represented as

Σₖ₌₁^{K}BHₘₖ⁽ⁱ⁾cₖ=0∀iϵS. Equation (50)

Similar to the single antenna embodiment, the condition given in equation (50) may provide low or substantially zero interference due to the suppressing signal. For single antenna communications, while the suppressing signal may not interfere with the data part of the OFDM symbol after it passes through the multipath channel, suppressing signals c₁ or c₂ transmitted from antennas 712 or 714 may cause interference to data d₁ or d₂ individually. However, the superposition of suppressing signals c₁ or c₂ at the receiver side may cancel each other on data d₁ and d₂. When suppressing signals c₁ or c₂ meet the condition given in equation (50), low or substantially zero interference is experienced when processing transmitted signals t₁ or t₂.

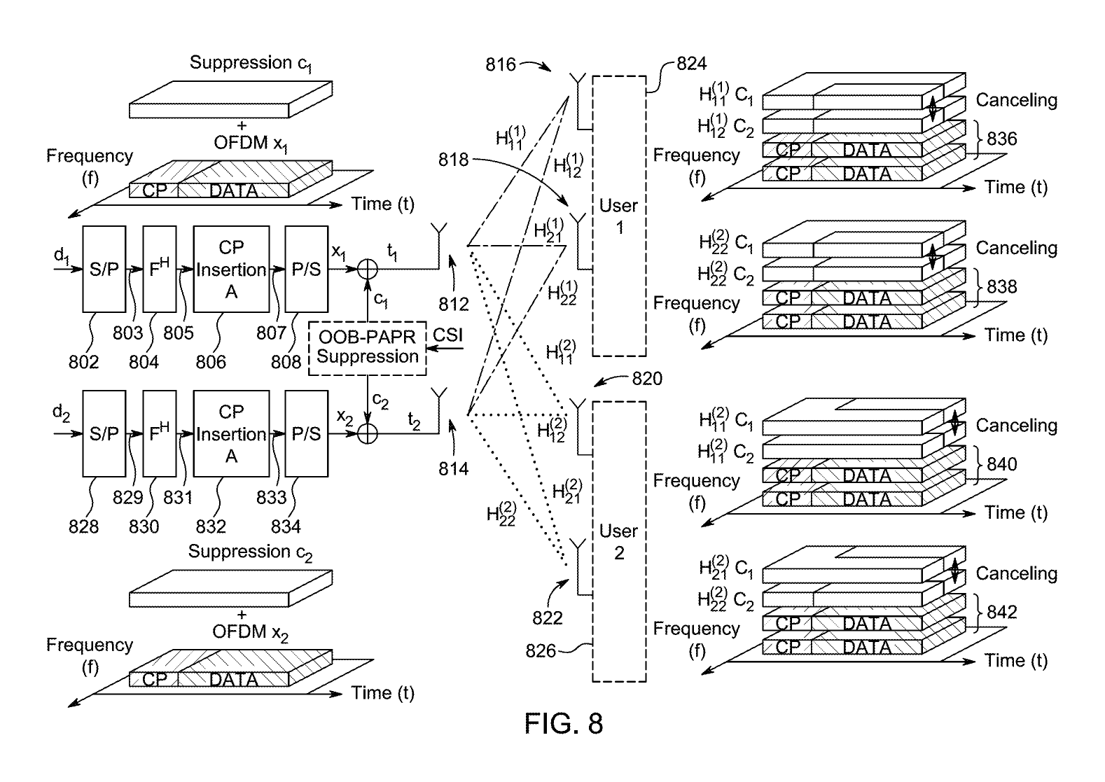

FIG. 8 is an illustration of MIMO suppressing alignment for multiple WTRUs that may utilize CSI. In FIG. 8, one of skill in the art will appreciate that data d₁ or d₂ may be selectively processed with a subset of the given components. With WTRUs or Users 1 and 2 824 and 826 utilizing antennas 816, 818, 820, and 822, cancellation may occur only at a certain parts of the OFDMA symbols 836, 838, 840, or 842. Thus, interference due to the suppressing signal may be aligned not only with a CP portion of the OFDMA symbol but also with subcarriers not utilized by the receivers.

Data d₁ is S/P converted by component 802 to produce signal 803 that is processed by IDFT component 804 to produce signal 805. As explained herewith, CP insertion block A component 806 produces signal 807 based on signal 805. P/S component 808 produces data symbol x₁ to be combined with suppressing signal c₁ to produce transmitted signal t₁ that is transmitted via antenna 812. As explained herewith, CSI information may be utilized by an OOB-PAPR suppression component to produce suppressing signals c₁.

Data d₂ is S/P converted by component 828 to produce signal 829 that is processed by IDFT component 830 to produce signal 831. As explained herewith, CP insertion block A component 832 produces signal 833 based on signal 831. P/S component 834 produces data symbol x₂ to be combined with suppressing signal c₂ to produce transmitted signal t₂ that is transmitted via antenna 814. As explained herewith, CSI information may be utilized by an OOB-PAPR suppression component to produce suppressing signals c₂.

A non-interfered part may be identified via the R(i) matrix and change depending on a WTRU. Suppressing signals which may substantially minimize or reduce the OOB leakage power or PAPR in multi transmit antenna configurations may be represented by

$$c = {arg}_{{c}^{′}}^{min} ( 1 - λ ) {‖ {F}_{OOB}^{block} ( x + {c}^{′} ) ‖}_{2} + λ {‖ ( x + {c}^{′} ) ‖}_{∞} \\ over {c}^{′} ∈ {C}^{K ( N + G ) \times 1} \\ subject to {\sum }_{k = 1}^{K} {R}^{( i )} {FBH}_{mk}^{( i )} {c}_{m} = 0 ∀ i ∈ S , ∀ m \\ {‖ {c}^{′} ‖}_{2} \leq \sqrt{∝} {‖ x ‖}_{2} , \qquad Equation ( 51 )$$

where F_{OOB}^{block}=I_{K}⊗F_{OOB} is the block diagonal matrix that extracts the spectral components of transmitted signals in the OOB region, x=vec ([x₁ x₂ . . . x_{K}]) is the concatenated signal vector, and c=vec ([c₁ c₂ . . . c_{K}]) is the solution vector. Similar to the expression given in equation (41), the parameter a limits the amount of power consumed by the suppressing signals as a fraction of the instantaneous total signal power and λϵ[0, 1] adjusts the objective function toward the OOB leakage or PAPR reduction.

In order to reduce the number of constraints in equation (51), a solution space for c′ may be found by constructing the constraint matrix as

$$M {=}^{△} [ \begin{matrix}{R}^{( 1 )} {FBH}_{11}^{( 1 )} & {R}^{( 1 )} {FBH}_{12}^{( 1 )} & … & {R}^{( 1 )} {FBH}_{1 K}^{( 1 )} \\ {R}^{( 1 )} {FBH}_{21}^{( 1 )} & {R}^{( 1 )} {FBH}_{22}^{( 1 )} & … & {R}^{( 1 )} {FBH}_{2 K}^{( 1 )} \\ ⋮ & ⋮ & ⋮ & ⋮ \\ {R}^{( 2 )} {FBH}_{11}^{( 2 )} & {R}^{( 2 )} {FBH}_{12}^{( 2 )} & … & {R}^{( 2 )} {FBH}_{1 K}^{( 2 )} \\ {R}^{( 2 )} {FBH}_{21}^{( 2 )} & {R}^{( 2 )} {FBH}_{22}^{( 2 )} & … & {R}^{( 2 )} {FBH}_{2 K}^{( 2 )} \\ ⋮ & ⋮ & ⋮ & ⋮ \\ {R}^{( S )} {FBH}_{M 1}^{( S )} & {R}^{( S )} {FBH}_{M 2}^{( S )} & … & {R}^{( S )} {FBH}_{MK}^{( S )}\end{matrix} ] . \qquad Equation ( 52 )$$

where Mc′=0. Each row of M may characterize the constraint for the mth receive antenna of the ith WTRU. Hence, the optimization problem given in equation (51) may be updated as

$$s = {arg}_{{s}^{′}}^{min} ( 1 - λ ) {‖ {F}_{OOB}^{block} ( x + {Es}^{′} ) ‖}_{2} + λ {‖ ( x + {Es}^{′} ) ‖}_{∞} \\ over {s}^{′} ∈ {C}^{D \times 1} \\ subject to {‖ {Es}^{′} ‖}_{2} \leq \sqrt{∝} {‖ x ‖}_{2} , \qquad Equation ( 53 )$$

where EϵC^{K(N+G)×D} is a matrix where its columns span the null space of M given in equation (52).

In a MIMO configuration with K and M antennas at the transmitter and receiver, respectively, a non-zero null space may be reached with the following condition

K(N+G)−MN>0, Equation (54)

being satisfied. In equation (54), the difference operation corresponds to the dimension of the null space or degrees-of-freedom. In addition, full MIMO multiplexing may need K≤M. Therefore, for a given number of transmit data and CP sizes, the difference between the number of transmitter and receiver antennas should satisfy

$$0 \leq M - K < \frac{G}{N} M . \qquad Equation ( 55 )$$

As the constraint matrix is defined in equation (52), to obtain a suppressing signal while decreasing energy in the public region or zone the following may be needed

$$s = {arg}_{{s}^{′}}^{min} {c}_{1} {‖ {F}_{OOB}^{block} ( x + {Es}^{′} ) ‖}_{2} + {c}_{2} {‖ ( x + {Es}^{′} ) ‖}_{∞} + {c}_{3} {‖ {F}_{public}^{block} ( {Es}^{′} ) ‖}_{2} \\ over {s}^{′} ∈ {C}^{D \times 1} \\ subject to {‖ {Es}^{′} ‖}_{2} \leq \sqrt{∝} {‖ x ‖}_{2} , \qquad Equation ( 56 )$$

where F_{public}^{block}=F_{public} is the block diagonal matrix for spectral content in the public region or zone for transmitted signals. Similar to equation (44), c₁, c₂, and c₃ correspond to the weighting factors as c₁=1−λ−γ, c₂=λ, and c₃=γ, which extends equation (53) to (56).

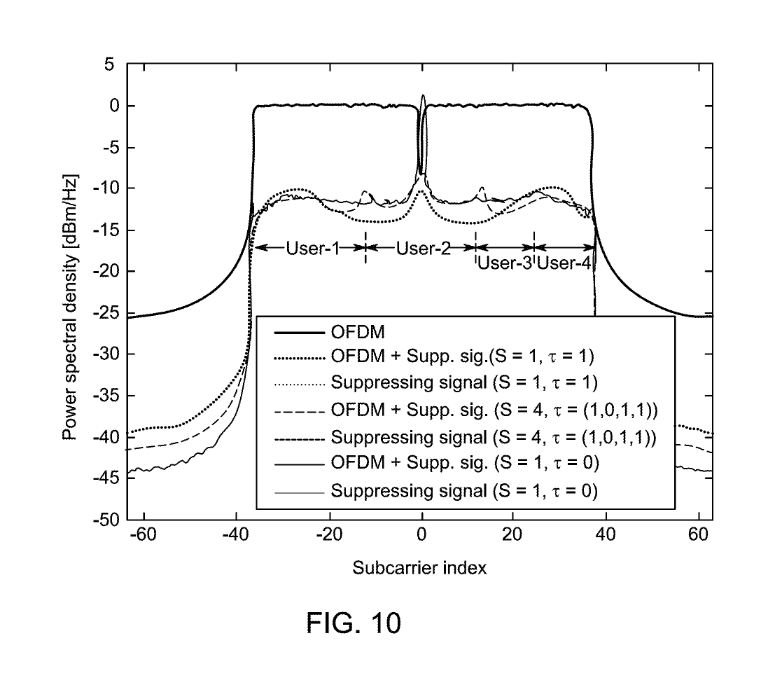

FIG. 10 is a graph of power spectral density (PSD) for single WTRU and multiple WTRU configurations. The configuration in FIG. 10 may be for a randomly generated Long Term Evolution (LTE) OFDMA communication with 4 WTRUs sharing 6 resource blocks using 16-QAM where each resource block consists of 12 subcarriers. The order of the resource block (RB) may be set to (2, 2, 1, 1). The number of subcarriers may be N=128 subcarriers and a CP length of G=9 samples. While the DC and non-utilized subcarriers are disabled, the remaining subcarriers may be shared by the receivers in the basis of resource blocks. The transmission is carried through a multipath Rayleigh fading channel with G+1 taps. The power delay profile (PDP) for this configuration may be exponentially decaying at a rate of τ. That is, the power of the last tap may be 30τ lower power compared to first tap. Lastly, τ=0 may correspond to uniform PDP.

The Welch's averaged periodogram method is utilized to estimate the power spectrum. The PAPR reduction performance may be evaluated using the complementary cumulative distribution function (CCDF). In certain simulations, the power of the suppressing signal may be constrained to be a fraction of the power of the OFDMA symbol (i.e., ∥c∥₂²≤∝∥x∥₂²).

The results in FIG. 10 may represent multiple WTRUs in the same OFDMA symbol or a hybrid channel matrix M as in equation (12). As explained herewith, this configuration may provide diversity benefits. It is desirable for a single WTRU with uniform PDP for better OOB leakage. Compared to a single WTRU case with fast decaying PDP, there may be a performance gain for the multiple WTRUs case, because a channel of user-2 may have a uniform delay spread where the suppressing signal power may be focused.

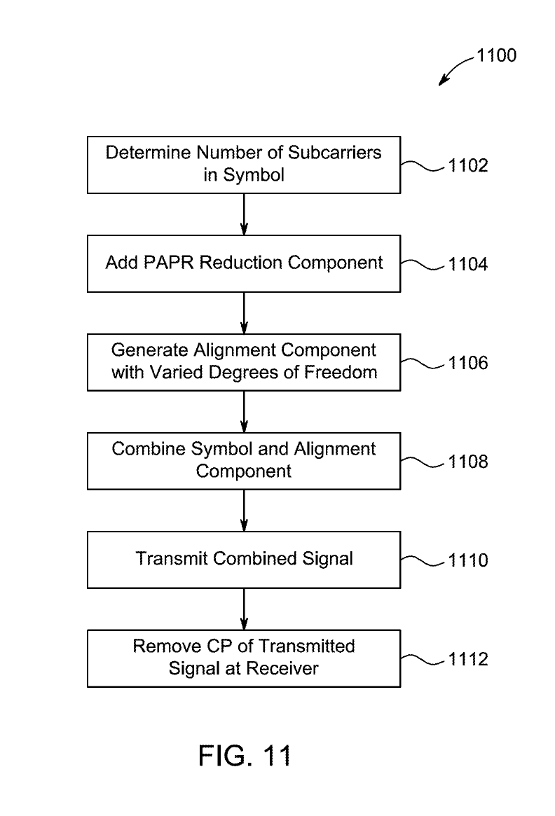

FIG. 11 is a process 1100 for generating, transmitting, and receiving a signal in accordance with the examples given herewith. A device, such as WTRU 102 or base stations 114a or 114b, may determine a number of subcarriers in symbol (1102). The symbol may be an FDM, SC-FDMA, OFDM, or OFDMA symbol. A PAPR reduction component may be added to a signal having the symbol (1104). An alignment component may be generated with varied degrees of freedom based on the degrees of freedom in the signal (1106). The signal may be combined with the alignment component (1108). The combined signal may be transmitted (1110) and a CP of the signal is removed at a receiver (1112) where the alignment component is substantially aligned to the CP duration or portion at the receiver.

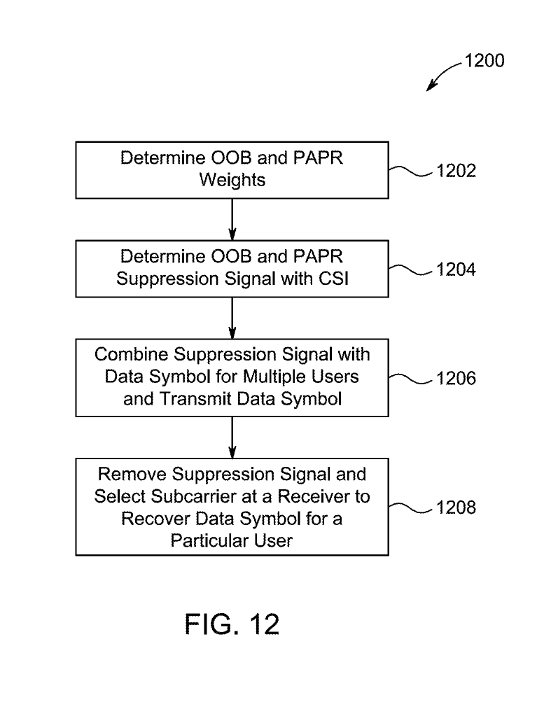

FIG. 12 is a process 1200 for generating a suppression signal with CSI for multiple WTRUs. A device, such as WTRU 102 or base stations 114a or 114b, may determine weights related to OOB leakage or PAPR reduction for a symbol transmission (1202). An OOB or PAPR suppression signal with utilization of CSI may then be determined (1204). The suppression signal may be combined with a data symbol for multiple users and transmitted (1206). The suppression signal is removed and a subcarrier is selected at a receiver to recover the data symbol for a particular user (1208).

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-15. (canceled)

16. A wireless transmit/receive unit (WTRU) comprising:
a processor configured to generate an N-continuous orthogonal frequency-division multiplexing (OFDM) symbol;
the processor further configured to add a cyclic prefix (CP) to the N-continuous OFDM symbol;
the processor further configured to generate an alignment signal, wherein the alignment signal includes a first number of subcarriers and the N-continuous OFDM symbol includes a second number of subcarriers and wherein the alignment signal is generated based on the first number of subcarriers to be aligned to a duration of the CP upon reception at a receiver;
the processor further configured to produce a signal having the alignment signal combined with the N-continuous OFDM symbol and the CP, wherein a first signal component is added to one or more of the first number of subcarriers to reduce peak-to-average ratio (PAPR) of the signal; and
a transceiver configured to transmit the signal.

17. The WTRU of claim 16, wherein the first number of subcarriers is equal to the second number of subcarriers.

18. The WTRU of claim 16, wherein the first number of subcarriers is greater than the second number of subcarriers.

19. The WTRU of claim 16, wherein a second signal component is added to one or more of the first number of subcarriers to reduce out of band (OOB) emissions.

20. A wireless transmit/receive unit (WTRU) comprising:
a processor configured to generate a frequency division multiplexing (FDM) based symbol to transmit in a first network, wherein the first network utilizes a same spectrum as a second network;
the processor further configured to add a cyclic prefix (CP) to the FDM based symbol;
the processor further configured to generate a suppression signal, wherein the suppression signal includes a first number of subcarriers and the FDM based symbol includes a second number of subcarriers and wherein the suppression signal is generated to be aligned to a duration of the CP or aligned to non-utilized subcarriers of the second number of subcarriers upon reception at one or more receivers of the second network;
the processor further configured to produce a signal having the suppression signal combined with the FDM based symbol and the CP, wherein a component is added to one or more of the first number of subcarriers to reduce peak-to-average ratio (PAPR) of the signal based on channel state information (CSI); and
a transceiver configured to transmit the signal.

21. The WTRU of claim 20, wherein the first network is public and associated with a first zone and the second network is private and associated with a second zone.

22. The WTRU of claim 20, wherein the FDM based symbol includes information for a first WTRU on a first subset of subcarriers of the second number of subcarriers and includes information for a second WTRU on a second subset of subcarriers of the second number of subcarriers.

23. The WTRU of claim 20, wherein the signal is transmitted via a first antenna and a second signal is generated with a second suppression signal and a second FDM based symbol to be transmitted via a second antenna.

24. The WTRU of claim 20, wherein the suppression signal includes power for energy harvesting by another WTRU.

25. The WTRU of claim 20, wherein the reduction of PAPR is associated with a first weight and a reduction of out-of-band (OOB) emissions is associated with a second weight.

26. The WTRU of claim 20 further comprising:
the processor further configured to generate a multiple-input multiple-output (MIMO) signal, wherein the MIMO signal includes a plurality of symbols combined with a plurality of suppression signals such that each suppression signal is aligned to a duration of each CP of each of the plurality of symbols upon reception.

27. A method performed by a wireless transmit/receive unit (WTRU), the method comprising:
generating, by a processor of the WTRU, an N-continuous orthogonal frequency-division multiplexing (OFDM) symbol;
adding, by the processor, a cyclic prefix (CP) to the N-continuous OFDM symbol;
generating, by the processor, an alignment signal, wherein the alignment signal includes a first number of subcarriers and the N-continuous OFDM symbol includes a second number of subcarriers and wherein the alignment signal is generated based on the first number of subcarriers to be aligned to a duration of the CP upon reception at a receiver;
producing, by the processor, a signal having the alignment signal combined with the N-continuous OFDM symbol and the CP, wherein a first signal component is added to one or more of the first number of subcarriers to reduce peak-to-average ratio (PAPR) of the signal; and
transmitting, by a transceiver of the WTRU, the signal.

28. The method of claim 27, wherein the first number of subcarriers is equal to the second number of subcarriers.

29. The method of claim 27, wherein the first number of subcarriers is greater than the second number of subcarriers.

30. The method of claim 27, wherein a second signal component is added to one or more of the first number of subcarriers to reduce out of band (OOB) emissions.
